(19) United States
(12) Patent Application Publication
(10) Pub. No.: US 2024/0386255 A1
(43) Pub. Date: Nov. 21, 2024

(54) HARDWARE-AWARE MIXED PRECISION QUANTIZATION METHOD AND SYSTEM BASED ON GREEDY SEARCH

(71) Applicants: Shanghai Jiao Tong University, Shanghai (CN); Inspur Academy of Science and Technology, Jinan (CN)

(72) Inventors: Xinfei Guo, Shanghai (CN); Xiaotian Zhao, Shanghai (CN); Ruge Xu, Shanghai (CN); Kai Jiang, Jinan (CN); Qiang Duan, Jinan (CN)

(21) Appl. No.: 18/664,441

(22) Filed: May 15, 2024

(30) Foreign Application Priority Data
May 16, 2023 (CN) 202310553723.3

(51) Int. Cl. G06N 3/0495

(52) U.S. Cl. CPC G06N 3/0495

(57) ABSTRACT

The present invention provides a hardware-aware mixed-precision quantization method and system based on a greedy search. It comprises quantizing all layers in the neural network to the uniform bit-width, conducting training-aware quantization, and acquiring the trained model, baseline inference accuracy, and total bit operation counts. Each layer in the neural network undergoes post-training quantization with low precision individually, and the corresponding inference accuracy and total bit operation counts for each layer are recorded. Single-layer sensitivity is computed based on the baseline inference accuracy, total bit operation counts, and the inference accuracy and total bit operation counts of each layer and guides the current total bit operation counts until reaching the preset maximum bit operation counts. Meanwhile, quantized layers and precision are recorded, determining the mixed-precision quantization strategy. This invention introduces single-layer sensitivity, wᵢ early in the search, thereby achieving an optimized quantization strategy that balances hardware costs and inference accuracy.

### CROSS-REFERENCE TO RELATED APPLICATIONS

This application claims priority of Chinese Patent Application No. 202310553723. 3, filed on May 16, 2023, the entire contents of which are incorporated herein by reference.

### TECHNICAL FIELD

The present invention relates to the field of mixed precision quantization technology. Specifically, it pertains to a hardware-aware mixed precision quantization method and system based on greedy search.

### BACKGROUND TECHNOLOGY

Quantization refers to the process of approximating the continuous values of a signal into a finite number of discrete values. It can be understood as a method of information compression. In the context of computer systems, this concept is generally represented as “low bits.” Some also refer to quantization as “fixed-point,” but strictly speaking, the represented range is reduced. Fixed-point specifically refers to linear quantization with a scale of power of 2, which is a more practical quantization method. To ensure high accuracy, most scientific computations in computer systems are performed using floating-point arithmetic, with common types being float32 and float64. Quantization of neural network models involves the process of converting the weights and activations of the network model from high precision to low precision, such as converting float32 to int8, while expecting the accuracy of the converted model to be close to that before conversion. Accuracy loss is a significant concern because model quantization is an approximate algorithm.

Patent document CN114492721A, with application number CN202011163813. 4, provides a mixed-precision quantization method for neural networks. This method determines the quantization precision of each layer based on the values of the objective functions corresponding to each layer without simultaneously considering the actual compression effect and hardware overhead.

Patent document CN115952842A, with application number CN202211662703. 1, provides a method for determining quantization parameters, a mixed-precision quantization method, and a device to achieve global and local optimization of precision quantization loss without simultaneously considering the actual compression effect and hardware overhead.

Patent document CN114492721A, with application number CN202011163813. 4, provides a depth neural network mixed-precision quantization method based on structural search. It utilizes advanced neural network structure search algorithms for searching, requiring extensive search and consuming a large amount of computing resources, thus making it inefficient for search.

Patent document CN112906883A with application number CN202110158390. 5 provides a method and system for determining mixed-precision quantization strategies for deep neural networks, solely optimizing for accuracy without simultaneously considering the actual compression effect and hardware overhead.

Patent document CN113449854A, with application number CN202111000718. 7, provides a mixed-precision quantization method, device, and computer storage medium for network models. Although it can automatically perform mixed-precision quantization bit operation counts on network models without requiring user-provided labeled data, it fails to guarantee that the overall consideration of precision and hardware overhead is taken into account during the quantization method search process.

Patent document CN114692818A, with application number CN202011622501. 5, provides a method to improve model accuracy using low-bit mixed precision quantization. Analyzing and computing the model channels ensures that the model achieves the same accuracy as 8-bit and full precision during the low-bit process. However, it cannot guarantee that the overall consideration of precision and hardware overhead is taken into account during the quantization method search process.

Patent document CN115719086A with application number CN202211469658. 8 provides a method for automatically obtaining the globally optimal strategy for mixed-precision quantization. By traversing all mixed quantization combinations, it can automatically find the globally mixed mixed-quantization combination. Although it mentions achieving global optimization, it fails to guarantee that the overall consideration of precision and hardware overhead is taken into account during the quantization method search process.

In summary, existing strategies for mixed-precision quantization mainly focus on accuracy metrics, lacking a method that simultaneously considers hardware overhead and accuracy in the search process. Additionally, due to the vast search space of mixed-precision quantization at the layer level, existing methods are unable to traverse the entire space, potentially missing the optimal strategy.

Therefore, there is a pressing need in the market for an efficient and precise hardware-aware mixed-precision quantization method and system based on greedy search.

### INVENTION CONTENT

In response to deficiencies in existing technology, the purpose of the present invention is to provide a hardware-aware mixed-precision quantization method and system based on greedy search.

A hardware-aware mixed-precision quantization method based on greedy search is provided by the present invention, comprising:

Step S1: Perform uniform bit-width high-precision quantization on all layers of the neural network, conduct training-aware quantization, and acquire the training model, baseline inference accuracy, and total bit operation counts.

Step S2: Each layer in the neural network undergoes post-training quantization with low precision individually, and the corresponding inference accuracy and total bit operation counts for each layer are recorded.

Step S3: Single-layer sensitivity is computed based on the baseline inference accuracy, total bit operation counts, as well as the inference accuracy and total bit operation counts corresponding to each layer.

Step S4: Current total bit operation counts are computed based on this single-layer sensitivity until reaching the preset maximum bit operation counts. Meanwhile, quantized layers and precision are recorded, determining the mixed-precision quantization strategy.

Preferably, the method involves individually quantizing each layer in a neural network with single-layer low-precision post-training quantization, wherein during quantization of the current layer with single-layer low precision, the remaining layers remain unchanged.

Preferably, calculating the sensitivity of each layer comprises:

Subtracting between the inference accuracy and the total bit operation counts corresponding to each layer and the baseline inference accuracy and total bit operation counts, respectively. The formula for this calculation is as follows:

$${w}_{i} = ( BOPs - {BOPs}_{i} ) / ( Acc - {Acc}_{i} )$$

Where wᵢ represents the single-layer sensitivity of the i-th layer, Acc denotes the baseline inference accuracy, Accᵢ represents the inference accuracy of the i-th layer, BOPs represents the difference in total bit operation counts, and BOPs; represents the total bit operation counts of the i-th layer.

Preferably, step S4 comprises:

Sorting the sensitivity of each layer from high to low, sequentially conducting low-precision quantization on each layer according to the sorted results, and calculating the current total bit operation counts until the current total bit operation counts reach the preset maximum bit operation counts. Recording the currently quantized layers and their corresponding quantization precision to determine the optimal mixed-precision quantization strategy.

Preferably, the preset maximum bit operation counts is set based on the maximum bit operation counts allowed by the actual hardware platform.

A hardware-aware mixed-precision quantization method based on greedy search is provided by the present invention, comprising:

Module M1: Perform uniform bit-width high-precision quantization on all layers of the neural network, conduct training-aware quantization, and acquire training model, baseline inference accuracy, and total bit operation counts.

Module M2: Each layer in the neural network undergoes post-training quantization with low precision individually, and the corresponding inference accuracy and total bit operation counts for each layer are recorded.

Module M3: Single-layer sensitivity is computed based on the baseline inference accuracy, total bit operation counts, as well as the inference accuracy and total bit operation counts corresponding to each layer.

Module M4: Current total bit operation counts are computed based on this single-layer sensitivity until reaching the preset maximum bit operation counts. Meanwhile, quantized layers and precision are recorded, determining the mixed-precision quantization strategy.

Preferably, the method involves individually quantizing each layer in a neural network with single-layer low-precision post-training quantization, wherein during quantization of the current layer with single-layer low precision, the remaining layers remain unchanged.

Preferably, calculating the sensitivity of each layer comprises:

Subtracting the corresponding inference accuracy and the total bit operation counts for each layer from the benchmark inference accuracy and total bit operation counts, respectively. The formula for this calculation is as follows:

$${w}_{i} = ( BOPs - {BOPs}_{i} ) / ( Acc - {Acc}_{i} )$$

Where wᵢ represents the single-layer sensitivity of the i-th layer, Acc denotes the baseline inference accuracy, Acc, represents the inference accuracy of the i-th layer, BOPs represents the difference in total bit operation counts, and BOPs; represents the total bit operation counts of the i-th layer.

Preferably, module M4 comprises:

Sorting the sensitivity of each layer from high to low, sequentially conducting low-precision quantization on each layer according to the sorted results, and calculating the current total bit operation counts until the current total bit operation counts reach the preset maximum bit operation counts. Recording the currently quantized layers and their corresponding quantization precision to determine the optimal mixed-precision quantization strategy.

Preferably, the preset maximum number of bit operation counts is set according to the maximum number of bit operation counts allowed by the actual hardware platform.

Compared with the prior art, the present invention has the following advantageous effects:
1. The present invention achieves an optimized quantization strategy that balances hardware overhead and inference accuracy by introducing a single-layer sensitivity in the early stages of a mixed-precision quantization search, thus capturing this sensitivity before the search.
2. By employing a greedy search and leveraging the incremental nature of layer-wise stacking, the present invention traverses all potential mixed-precision quantization strategies within a large search space to ensure rapid and efficient identification of the optimal strategy.

### DRAWING DESCRIPTION

Further features, objectives, and advantages of the present invention will become apparent by reading the detailed description of non-limiting embodiments provided concerning the following figures:

FIG. 1 illustrates the workflow of the present invention.

### MODE OF CARRYING OUT THE INVENTION

Specific embodiments of the present invention are described below. These embodiments will assist those skilled in the art in further understanding the present invention but do not limit the invention in any form. It should be noted that, for those skilled in the art, various changes and improvements can be made without departing from the conceptual scope of the present invention. These are all within the scope of protection of the present invention.

The present invention finds the optimal neural network quantization strategy from a vast search space while considering both precision and hardware overhead.

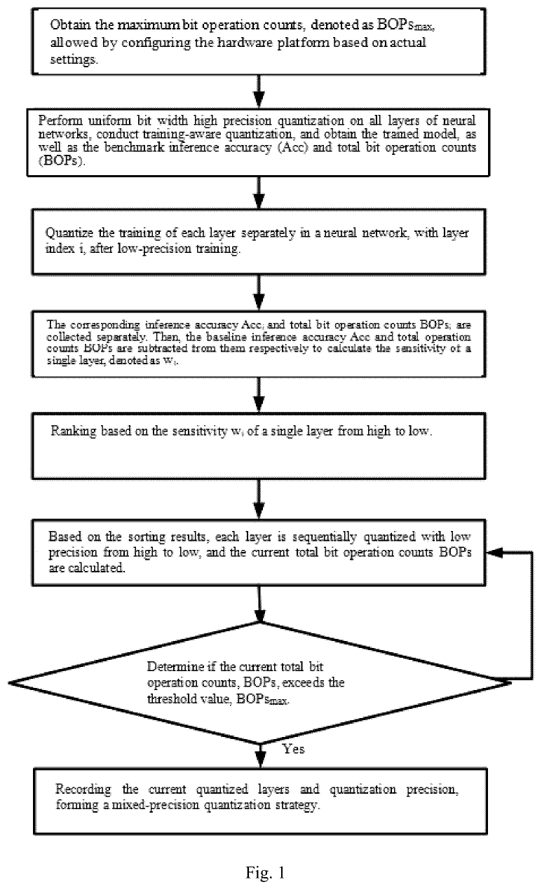

According to the present invention, a hardware-aware mixed-precision quantization method based on greedy search is provided, as illustrated in FIG. 1, comprising:

Step S1: Perform uniform bit-width high-precision quantization on all layers of the neural network, conduct training-aware quantization, and acquire the training model, baseline inference accuracy, and total bit operation counts.

Step S2: Perform single-layer low-precision post-training quantization on each neural network layer and record the corresponding inference accuracy and total bit operation counts for each layer. Specifically, the method involves individually applying single-layer low-precision post-training quantization to each layer of the neural network, wherein conducting single-layer low-precision post-training quantization on each neural network layer while keeping the other layers unchanged. This step enables the independent collection of sensitivity wᵢ for each layer, followed by sorting all layers based on sensitivity, thereby preparing for the search method of the present invention.

Step S3: Calculate the sensitivity of each layer based on the baseline inference accuracy and total bit operation counts, as well as the inference accuracy and total bit operation counts corresponding to each layer. Calculating the sensitivity of each layer involves subtracting the corresponding inference accuracy and total bit operation counts of each layer from the baseline inference accuracy and total bit operation counts. The formula for this calculation is as follows:

$${w}_{i} = ( BOPs - {BOPs}_{i} ) / ( Acc - {Acc}_{i} )$$

Where w₁ represents the single-layer sensitivity of the i-th layer, Acc denotes the baseline inference accuracy, Accᵢ represents the inference accuracy of the i-th layer, BOPs represents the difference in total bit operation counts, and BOPs; represents the total bit operation counts of the i-th layer.

The present invention achieves an optimized quantization strategy by introducing a single-layer sensitivity within a mixed-precision quantization search, collecting this sensitivity in the early stage of the search process, thereby balancing hardware overhead and inference accuracy. Specifically, the single-layer sensitivity wᵢ consists of two metrics: total bit operation counts BOPs and accuracy Acc. BOPs represents hardware proxy and are constrained by the actual hardware computational capability to determine the maximum BOPs. Traditional search processes typically prioritize Acc without considering metrics such as BOPs during the search.

Step S4: Calculate the current total bit operation counts based on the single-layer sensitivity until the preset maximum bit operation counts are reached. Simultaneously, the quantized layers and precision are recorded to determine the mixed-precision quantization strategy. Step S4 comprises sorting the single-layer sensitivities of each layer from high to low, sequentially quantizing each layer with low precision based on the sorting results, and calculating the current total bit operation counts until the preset maximum bit operation counts are reached. Record the currently quantized layers and their corresponding precision to determine the optimal mixed-precision quantization strategy. The preset maximum bit operation counts are set according to the maximum bit operation counts allowed by the actual hardware platform.

Furthermore, combined with the accompanying drawings, the specific description of the hardware-aware mixed-precision quantization method based on greedy search in the present invention is as follows:

The greedy search in the present invention divides the optimization problem into an element set. At each step, a greedy heuristic is used to find the current optimal quantization strategy, which is then used in the next step of the search iteratively until a globally optimal quantization combination scheme is generated. Then, leveraging the layer-wise stackable feature, all possible mixed-precision quantization strategies are traversed to ensure the rapid and effective discovery of the optimal strategy in a larger search space. Specifically, the steps include:

Step 1: Obtain the maximum bit operation counts BOPsₘₐₓ allowed by the actual hardware platform settings.

Step 2: Quantize all layers in the neural network to the same bit width, such as 8 bits, for training-aware quantization. Obtain the trained model and baseline inference accuracy Acc and total bit operation counts BOPs.

Step 3: Perform single-layer, layer number denoted as i, low-precision post-training quantization on each layer of the neural network, for example, 4 bits, while keeping other layers unchanged. Collect the corresponding inference accuracy Accᵢ and total bit operation counts BOPsᵢ, then subtract the baseline inference accuracy Acc and total bit operation counts BOPs obtained in Step 2, and calculate the single-layer sensitivity w₁ as (BOPs−BOPsᵢ)/(Acc−Acc₁).

Step 4: Sort the single-layer sensitivities wᵢ from high to low.

Step 5: Based on the sorting results from Step 4, each layer is sequentially subjected to low-precision quantization in descending order, and the current total bit operation counts BOPs are calculated.

Step 6: Determine whether the current total bit operation counts BOPs exceeds the threshold BOPsₘₐₓ. If yes, record the layers that have been quantized and the quantization precision, forming a mixed-precision quantization strategy; if not, return to Step 5.

The present invention traverses all combinations of inter-layer quantization without early elimination of any scheme. Additionally, during the search process, considerations are particularly given to situations where different quantization combinations result in similar or close accuracy, thus maximizing the assurance that the optimal solution is not overlooked.

The present invention also provides a hardware-aware mixed-precision quantization system based on greedy search, which technical personnel in the field can implement the hardware-aware mixed-precision quantization system by executing the steps of the hardware-aware mixed-precision quantization method based on greedy search. Thus, the hardware-aware mixed-precision quantization method based on greedy search can be understood as a preferred embodiment of the hardware-aware mixed-precision quantization system.

A hardware-aware mixed-precision quantization system based on greedy search is provided by the present invention, comprising:

Module M1: Perform uniform bit-width high-precision quantization on all layers of the neural network, conduct training-aware quantization, and acquire training model, baseline inference accuracy, and total bit operation counts.

Module M2: Perform single-layer low-precision post-training quantization on each neural network layer individually and record the corresponding inference accuracy and total bit operation counts for each layer. Individually applying single-layer low-precision post-training quantization to each layer of a neural network. This means that the remaining layers remain unchanged while quantizing a current layer with single-layer low-precision post-training quantization.

Module M3: Calculate the single-layer sensitivity based on the baseline inference accuracy and total bit operation counts, as well as the inference accuracy and corresponding total bit operation counts for each layer. Calculating single-layer sensitivity includes subtracting each layer's inference accuracy and corresponding total bit operation counts from the baseline inference accuracy and total bit operation counts, respectively. The calculation formula is as follows:

$${w}_{i} = ( BOPs - {BOPs}_{i} ) / ( Acc - {Acc}_{i} )$$

Where wᵢ represents the single-layer sensitivity of the i-th layer, Acc denotes the baseline inference accuracy, Accᵢ represents the inference accuracy of the i-th layer, BOPs represents the difference in total bit operation counts, and BOPs; represents the total bit operation counts of the i-th layer.

Module M4: Calculate the current total bit operation counts based on single-layer sensitivities until reaching the preset maximum bit operation counts while recording quantized layers and quantization precision to determine a mixed-precision quantization strategy. Module M4 comprises sorting the single-layer sensitivities of each layer from high to low, sequentially quantizing each layer at low precision based on the sorting results, calculating the current total bit operation counts until it reaches the preset maximum bit operation counts, recording the currently quantized layers and their corresponding quantization precision, thereby determining the optimal mixed-precision quantization strategy. The preset maximum bit operation counts are set according to the maximum bit operation counts allowed by the actual hardware platform.

Those skilled in the art will understand that besides implementing the system, device, and each module provided by the present invention in pure computer-readable program code, the same program can be implemented by logically programming the method steps, rendering the system, device, and each module provided by the present invention in the form of logic gates, switches, dedicated integrated circuits, programmable logic controllers, and embedded microcontrollers. Thus, the system, device, and each module provided by the present invention can be considered as hardware components, and the modules for implementing various programs contained therein can also be viewed as structures within hardware components; alternatively, the modules for implementing various functions can be regarded as both software programs for implementing methods and structures within hardware components.

The specific embodiments of the present invention have been described above. It should be understood that the present invention is not limited to the specific embodiments described above, and those skilled in the art can make various changes or modifications within the scope of the claims without departing from the essence of the present invention. In non-conflicting situations, features in the embodiments and examples of this application can be arbitrarily combined with each other.

1. A hardware-aware mixed-precision quantization method based on the greedy search is characterized in that comprises:
Step S1: Perform uniform bit-width high-precision quantization on all layers of the neural network, conduct training-aware quantization, and acquire the training model, baseline inference accuracy, and total bit operation counts;
Step S2: Each layer in the neural network undergoes post-training quantization with low precision individually, and the corresponding inference accuracy and total bit operation counts for each layer are recorded;
Step S3: Single-layer sensitivity is computed based on the baseline inference accuracy, total bit operation counts, as well as the inference accuracy and total bit operation counts corresponding to each layer;
Step S4: Current total bit operation counts are computed based on this single-layer sensitivity until reaching the preset maximum bit operation counts. Meanwhile, quantized layers and precision are recorded, determining the mixed-precision quantization strategy.

2. The hardware-aware mixed-precision quantization method based on greedy search, as described in claim 1, is characterized by individually quantizing each neural network layer with single-layer low precision after training; The other layers remain unchanged during the single-layer low-precision quantization of the current layer.

3. The hardware-aware mixed-precision quantization method based on greedy search, as described in claim 1, is characterized in that the computing single-layer sensitivity comprises:
Subtracting the inference accuracy and the total bit operation counts corresponding to each layer with the baseline inference accuracy and total bit operation counts, respectively, The formula for this calculation is as follows:
$${w}_{i} = ( BOPs - {BOPs}_{i} ) / ( Acc - {Acc}_{i} )$$
Where w₁ represents the single-layer sensitivity of the i-th layer, Acc denotes the baseline inference accuracy, Accᵢ represents the inference accuracy of the i-th layer, BOPs represents the difference in total bit operation counts, and BOPs; represents the total bit operation counts of the i-th layer.

4. The hardware-aware mixed-precision quantization method based on greedy search, according to claim 1, is characterized in that Step S4 comprises:
Sorting the sensitivity of each layer from high to low, sequentially conducting low-precision quantization on each layer according to the sorted results, and calculating the current total bit operation counts until the current total bit operation counts reach the preset maximum bit operation counts. Recording the currently quantized layers and their corresponding quantization precision to determine the optimal mixed-precision quantization strategy.

5. The hardware-aware mixed-precision quantization method, based on greedy search according to claim 4, is characterized in that the preset maximum total bit operation counts are set based on the actual maximum bit operation counts allowed by the hardware platform.

6. A hardware-aware mixed-precision quantization system based on the greedy search is characterized in that comprises:
Module M1: Perform uniform bit-width high-precision quantization on all layers of the neural network, conduct training-aware quantization, and acquire training model, baseline inference accuracy, and total bit operation counts;
Module M2: Each layer in the neural network undergoes post-training quantization with low precision individually, and the corresponding inference accuracy and total bit operation counts for each layer are recorded;
Module M3: Single-layer sensitivity is computed based on the baseline inference accuracy, total bit operation counts, as well as the inference accuracy and total bit operation counts corresponding to each layer;
Module M4: Current total bit operation counts are computed based on this single-layer sensitivity until reaching the preset maximum bit operation counts. Meanwhile, quantized layers and precision are recorded, determining the mixed-precision quantization strategy.

7. A hardware-aware mixed-precision quantization system based on greedy search, as described in claim 6, is characterized in that for each layer of the neural network, single-layer low-precision post-training quantization is performed separately, including when performing single-layer low-precision post-training quantization for the current layer, the remaining layers remain unchanged.

8. A hardware-aware mixed-precision quantization system based on greedy search, as described in claim 6, is characterized in that computing single-layer sensitivity includes:
Subtracting the corresponding inference accuracy and the total bit operation counts for each layer from the benchmark inference accuracy and total bit operation counts, respectively; The formula for this calculation is as follows:
$${w}_{i} = ( BOPs - {BOPs}_{i} ) / ( Acc - {Acc}_{i} )$$
Where wᵢ represents the single-layer sensitivity of the i-th layer, Acc denotes the baseline inference accuracy, Accᵢ represents the inference accuracy of the i-th layer, BOPs represents the difference in total bit operation counts, and BOPS; represents the total bit operation counts of the i-th layer.

9. A hardware-aware mixed-precision quantization system based on greedy search, as described in claim 6, is characterized in that module M4 comprises:
Sorting the sensitivity of each layer from high to low, sequentially conducting low-precision quantization on each layer according to the sorted results, and calculating the current total bit operation counts until the current total bit operation counts reach the preset maximum bit operation counts. Recording the currently quantized layers and their corresponding quantization precision to determine the optimal mixed-precision quantization strategy.

10. A hardware-aware mixed-precision quantization system based on greedy search, as described in claim 9, is characterized in that the preset maximum bit operation counts is set according to the maximum bit operation counts allowed by the actual hardware platform.
